(19) United States
(12) Patent Application Publication
(10) Pub. No.: US 2025/0141288 A1
(43) Pub. Date: May 1, 2025

(54) ROTATING ELECTRIC MACHINE

(71) Applicant: DENSO CORPORATION, Kariya-city (JP)

(72) Inventors: Tomohiro AOYAMA, Kariya-city (JP); Takahiro NAKAYAMA, Kariya-city (JP)

(73) Assignee: DENSO CORPORATION, Kariya-city (JP)

(21) Appl. No.: 19/010,357

(22) Filed: Jan. 6, 2025

Related U.S. Application Data
(63) Continuation of application No. PCT/JP2023/024595, filed on Jul. 3, 2023.

(30) Foreign Application Priority Data
Jul. 6, 2022 (JP) 2022-109159

(51) Int. Cl. H02K 1/276; H02K 21/16; H02K 29/03

(52) U.S. Cl. CPC H02K 1/2773; H02K 21/16; H02K 29/03; H02K 2201/06

(57) ABSTRACT

A rotor includes a plurality of magnetic poles each of which has one slit formed in a rotor core. Each of the magnetic poles is divided into twelve equal areas between first and second circumferential ends thereof. Counting the twelve areas in order of proximity to the first circumferential end, the fourth to ninth areas are respectively defined as a first area, a second area, a third area, a fourth area, a fifth area and a sixth area. The slits of the magnetic poles include a first slit and a second slit. The first slit is arranged in the third area or the sixth area. The second slit is arranged in one of the first area, the second area, the third area, the fourth area, the fifth area and the sixth area.

### CROSS-REFERENCE TO RELATED APPLICATIONS

The present application is a continuation application of International Application No. PCT/JP2023/024595 filed on Jul. 3, 2023, which is based on and claims priority from Japanese Patent Application No. 2022-109159 filed on Jul. 6, 2022. The entire contents of these applications are incorporated by reference into the present application.

### BACKGROUND

### 1 Technical Field

The present disclosure relates to rotating electric machines.

### 2 Description of Related Art

In the field of rotating electric machines, interior permanent magnet rotors are well known which have permanent magnets embedded in a rotor core. The interior permanent magnet rotors have a plurality of magnetic poles formed in a circumferential direction thereof, each of the magnetic poles includes one of the permanent magnets and a portion of the rotor core. Moreover, the interior permanent magnet rotors are configured to obtain both magnet torque generated by the permanent magnets and reluctance torque generated by the portions of the rotor core. For example, Japanese Patent Application Publication No. JP H10-285845 A discloses an interior permanent magnet rotor in which the magnetic poles have slits formed in the rotor core. By the action of the slits, it becomes possible to reduce torque ripple.

### SUMMARY

The arrangement of slits in rotors as described above has been investigated by the inventors of the present application to more effectively reduce torque ripple.

The present disclosure has been accomplished based on the results of the investigation by the inventors of the present application.

According to the present disclosure, a rotating electric machine includes: a rotor including a rotor core and a plurality of permanent magnets embedded in the rotor core; and a stator configured to apply a rotating magnetic field to the rotor. The rotor has a plurality of magnetic poles formed at equal angular intervals in a circumferential direction. Each of the magnetic poles includes a corresponding one of the permanent magnets and a corresponding portion of the rotor core. Each of the magnetic poles has one slit formed in the corresponding portion of the rotor core. In each of the magnetic poles, an angle from a first circumferential end to a second circumferential end of the magnetic pole is 360°/P, where P is the number of the magnetic poles. Each of the magnetic poles is divided into twelve equal areas between the first and second circumferential ends thereof. Counting the twelve areas in order of proximity to the first circumferential end, the fourth to ninth areas are respectively defined as a first area, a second area, a third area, a fourth area, a fifth area and a sixth area. The slits of the magnetic poles include a first slit and a second slit. The first slit is arranged in the third area or the sixth area. The second slit is arranged in one of the first area, the second area, the third area, the fourth area, the fifth area and the sixth area.

With the above configuration, the width of the phase range of torque ripple when the position of a slit is changed in the circumferential direction is greater in the third area and the sixth area than in the other areas (see FIG. 6). Therefore, with the first slit arranged in the third area or the sixth area, it is possible to improve the degree of freedom in setting the position of the second slit so as to enable the second slit to generate torque ripple in the opposite phase to that generated by the first slit.

### BRIEF DESCRIPTION OF THE DRAWINGS

FIG. 1 is a configuration diagram of a rotating electric machine according to an embodiment.

FIG. 2 is a plan view showing part of a rotor according to the embodiment.

FIG. 3 is another plan view showing part of the rotor according to the embodiment.

FIG. 4 is an explanatory diagram for explaining the setting of positions of slits in the rotor according to the embodiment.

FIG. 5 is another explanatory diagram for explaining the setting of positions of slits in the rotor according to the embodiment.

FIG. 6 is a graph for explaining the setting of positions of slits in the rotor according to the embodiment.

FIG. 7 is another graph for explaining the setting of positions of slits in the rotor according to the embodiment.

FIG. 8 is a table for explaining patterns of arranging slits in the rotor according to the embodiment and the magnitude of the effect of each of the patterns.

FIG. 9 is an explanatory diagram for explaining the setting of positions of slits in the rotor according to the embodiment.

FIG. 10 is another explanatory diagram for explaining the setting of positions of slits in the rotor according to the embodiment.

FIG. 11 is another explanatory diagram for explaining the setting of positions of slits in the rotor according to the embodiment.

FIG. 12 is an explanatory diagram for explaining a rotor according to a modification of the embodiment.

FIG. 13 is a perspective view of the rotor according to the modification shown in FIG. 12.

FIG. 14 is an explanatory diagram for explaining a rotor according to another modification of the embodiment.

FIG. 15 is a perspective view of the rotor according to the modification shown in FIG. 14.

FIG. 16 is a perspective view of a rotor according to another modification of the embodiment.

FIG. 17 is a plan view of a rotor according to another modification of the embodiment.

### DESCRIPTION OF EMBODIMENTS

Hereinafter, an embodiment of a rotating electric machine will be described.

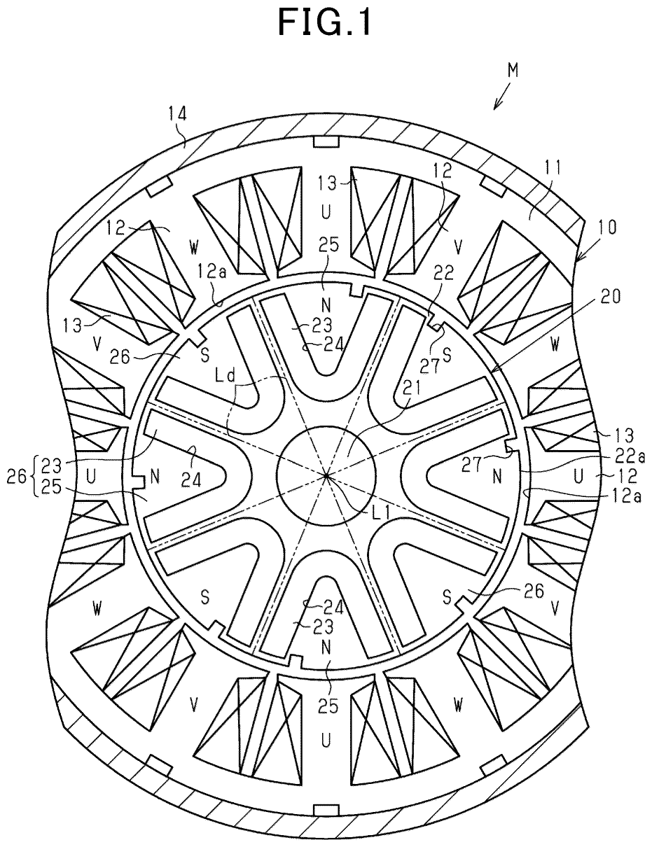

As shown in FIG. 1, a rotating electric machine M according to the present embodiment is configured as an interior permanent magnet brushless motor. The rotating electric machine M includes a substantially annular stator 10 and a substantially cylindrical rotor 20 that is rotatably arranged in a space radially inside the stator 10. The stator 10 is configured to apply a rotating magnetic field to the rotor 20.

### (Configuration of Stator 10)

The stator 10 includes a substantially annular stator core 11. The stator core 11 is formed of a magnetic metal material. For example, the stator core 11 may be formed by laminating a plurality of magnetic steel sheets in the direction of an axis L1. The stator core 11 has a plurality (more particularly, twelve in the present embodiment) of teeth 12 extending radially inward and arranged at equal intervals in the circumferential direction. That is, in the present embodiment, the number of slots of the stator 10 is twelve. All the teeth 12 are identical in shape to each other. Each of the teeth 12 has a substantially T-shaped radially inner end portion (i.e., distal end portion) and a distal end surface 12a formed in an arc shape along an outer circumferential surface of the rotor 20.

Windings 13 are wound around the teeth 12 in a concentrated winding manner. The windings 13 are connected in three phases to respectively function as a U-phase, a V-phase and a W-phase as shown in FIG. 1. Upon supply of electric power to the windings 13, the stator 10 generates the rotating magnetic field, thereby driving the rotor 20 to rotate. In addition, in the stator 10, an outer circumferential surface of the stator core 11 is fixed to an inner circumferential surface of a housing 14.

### (Configuration of Rotor 20)

The rotor 20 includes a rotating shaft 21, a substantially cylindrical rotor core 22 having the rotating shaft 21 inserted in a central part thereof, and a plurality (more particularly, eight in the present embodiment) of permanent magnets 23 embedded in the rotor core 22.

The rotor core 22 is formed of a magnetic metal material. For example, the rotor core 22 may be formed by laminating a plurality of magnetic steel sheets in the direction of the axis L1. The rotor 20 is rotatably arranged with respect to the stator 10, with the rotating shaft 21 supported by bearings (not shown) provided in the housing 14.

The rotor core 22 has a plurality of magnet-receiving holes 24 for receiving the permanent magnets 23 therein. More particularly, in the present embodiment, eight magnet-receiving holes 24 are formed at equal intervals in the circumferential direction of the rotor core 22. Each of the magnet-receiving holes 24 has a folded substantially V-shape that is convex radially inward when viewed in the axial direction. All the magnet-receiving holes 24 are identical in shape to each other. In addition, each of the magnet-receiving holes 24 is formed over the entire axial length of the rotor core 22.

In the present embodiment, the permanent magnets 23 are implemented by bonded magnets that are formed by molding and solidifying a magnet material; the magnet material is a mixture of a magnet powder and a resin. More specifically, in the present embodiment, the magnet-receiving holes 24 of the rotor core 22 serve as forming molds. The permanent magnets 23 are formed by: filling the magnet material, which has not been solidified, into the magnet-receiving holes 24 of the rotor core 22 by injection molding without any gaps remaining therein; and then solidifying the magnet material in the magnet-receiving holes 24. Consequently, the external shape of the permanent magnets 23 conforms to the shape of the magnet-receiving holes 24 of the rotor core 22. In addition, in the present embodiment, a samarium-iron-nitrogen-based (i.e., SmFeN-based) magnet powder is employed as the magnet powder for forming the permanent magnets 23. It should be noted that other rare-earth magnet powders may alternatively be employed as the magnet powder for forming the permanent magnets 23.

The permanent magnets 23, which are provided in the magnet-receiving holes 24 of the rotor core 22, are magnetized, after solidification of the magnet material, by a magnetizing apparatus (not shown) located outside the rotor core 22, so as to function as genuine permanent magnets. More specifically, in the present embodiment, eight permanent magnets 23 are arranged in the circumferential direction of the rotor core 22 and magnetized so that the polarities of the permanent magnets 23 are alternately different in the circumferential direction. In addition, each of the permanent magnets 23 is magnetized in its thickness direction.

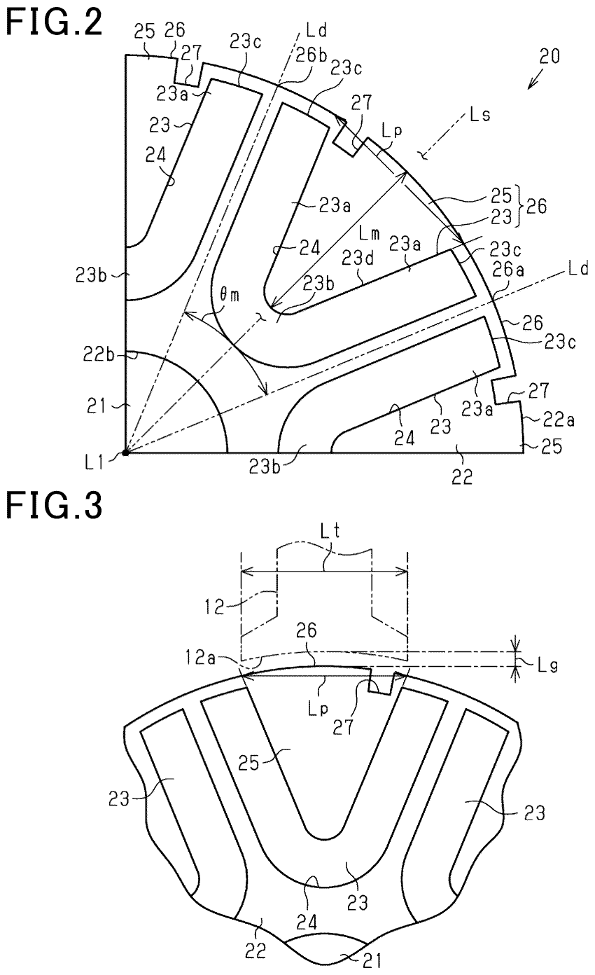

Each of the permanent magnets 23 has a folded substantially V-shape that is convex radially inward. More specifically, as shown in FIG. 2, each of the permanent magnets 23 has a shape such that the radially inner ends of a pair of straight portions 23a are connected by a curved portion 23b. The radially outer ends 23c of the pair of straight portions 23a are located near the outer circumferential surface 22a of the rotor core 22.

Moreover, each of the permanent magnets 23 has an axisymmetric shape with respect to a circumferential centerline Ls thereof passing through the axis L1 of the rotor 20. Furthermore, the permanent magnets 23 are located in close proximity to magnetic-pole boundary lines Ld each extending between a circumferentially adjacent pair of the permanent magnets 23. In addition, when viewed in the direction of the axis L1, the magnetic-pole boundary lines Ld each extend straight through the axis L1 to delimit magnetic poles 26 (to be described later) of the rotor 20.

For each of the V-shaped permanent magnets 23, the distance between the intersection points between extension lines of inside surfaces of the straight portions 23a of the permanent magnet 23 and the outer circumferential surface 22a of the rotor core 22 is defined as a magnetic pole pitch Lp; and the distance on the circumferential centerline Ls of the permanent magnet 23 from the outer circumferential surface 22a of the rotor core 22 to an inside surface of the curved portion 23b of the permanent magnet 23 is defined as an embedding depth Lm. In the present embodiment, each of the permanent magnets 23 is formed to have a deep folded shape such that the embedding depth Lm is larger than the magnetic pole pitch Lp. That is, in the present embodiment, for each of the V-shaped permanent magnets 23, the magnet surface 23d of the permanent magnet 23, which is constituted of the inside surfaces of the straight portions 23a and curved portion 23b of the permanent magnet 23, is set to be larger than the magnet surface of a well-known surface permanent magnet rotor (not shown). Setting the embedding depth Lm to be large, the curved portions 23b of the permanent magnets 23 are located radially inward near a shaft insertion hole 22b which is formed in the central part of the rotor core 22 and in which the rotating shaft 21 is inserted. It should be noted that: the above-described folded shape is merely an example of the shape of the permanent magnets 23; and the permanent magnets 23 may be suitably modified to have other shapes, such as a folded substantially V-shape with a small embedding depth Lm or a folded substantially U-shape with a large curve portion 23b. In the rotor 20 according to the present embodiment, since each of the permanent magnets 23 has a folded substantially V-shape that is convex radially inward, it becomes easy to set the radial range within which the permanent magnets 23 are provided to be wider than that in the aforementioned surface permanent magnet rotor.

Those portions of the rotor core 22 which are located on the inner side of the folded substantially V-shape of the permanent magnets 23 and radially outside the permanent magnets 23 function as outer core portions 25 facing the stator 10 to generate reluctance torque. When viewed in the axial direction, each of the outer core portions 25 has a substantially triangular shape with one vertex oriented toward the central part of the rotor 20.

The rotor 20 has a plurality of magnetic poles 26 arranged side by side in the circumferential direction. Each of the magnetic poles 26 includes a corresponding one of the permanent magnets 23 and a corresponding one of the outer core portions 25 which is located inside and surrounded by the corresponding V-shaped permanent magnet 23. In addition, the magnetic poles 26 are formed at equal angular intervals in the circumferential direction.

Each of the magnetic poles 26 has a first end 26a that is one circumferential end of the magnetic pole 26, and a second end 26b that is the other circumferential end of the magnetic pole 26. The positions of the first end 26a and the second end 26b in the circumferential direction respectively coincide with the corresponding magnetic-pole boundary lines Ld. In addition, in the drawings, the counterclockwise direction is defined as a forward rotational direction whereas the clockwise direction is defined as a reverse rotational direction; in each of the magnetic poles 26, the front end in the forward rotational direction is the second end 26b whereas the rear end in the forward rotational direction is the first end 26a.

In each of the magnetic poles 26, the magnetic-pole opening angle θm, which is defined as the angle from the first end 26a to the second end 26b about the axis L1, is equal to 360°/P, where P is the number of magnetic poles of the rotor 20 (i.e., the number of the magnetic poles 26). In the rotor 20 according to the present embodiment, the number of the magnetic poles 26 is set to eight. Therefore, the magnetic-pole opening angle θm of each of the magnetic poles 26 is equal to 45°. As shown in FIG. 1, the magnetic poles 26 function as N poles and S poles alternately in the circumferential direction. The rotor 20 having the magnetic poles 26 as described above can properly generate both magnet torque and reluctance torque.

As shown in FIG. 3, an air gap Lg is formed between the outer circumferential surface 22a of the rotor core 22 and the distal end surfaces 12a of the teeth 12. Moreover, the size of the magnetic pole pitch Lp is set to be within the following range: Lt−(Lg×2)≤Lp≤Lt+(Lg×2), where Lt is the width of each of the distal end surfaces 12a of the teeth 12. In addition, for each of the distal end surfaces 12a of the teeth 12, Lt is defined as the width of the distal end surface 12a in the direction perpendicular to both the axial direction and a radial direction. Setting the size of the magnetic pole pitch Lp to be within the above range, it is possible to make the size of the magnetic pole pitch Lp approximately equal to the width of each of the distal end surfaces 12a of the teeth 12. As a result, the rotational torque of the rotor 20 can be obtained efficiently.

### (Configuration of Slits 27)

As shown in FIG. 1, each of the magnetic poles 26 has one slit 27 formed in an outer surface of the corresponding outer core portion 25. The slit 27 has the shape of a groove formed in the outer surface of the corresponding outer core portion 25. That is, the slit 27 is formed to be recessed radially inward from the outer surface of the corresponding outer core portion 25. In addition, the outer surface of the corresponding outer core portion 25 is a part of the outer circumferential surface 22a of the rotor core 22. Moreover, the slit 27 is formed to extend straight along the axis L1.

### (Setting of Positions of Slits 27 in Magnetic Poles 26)

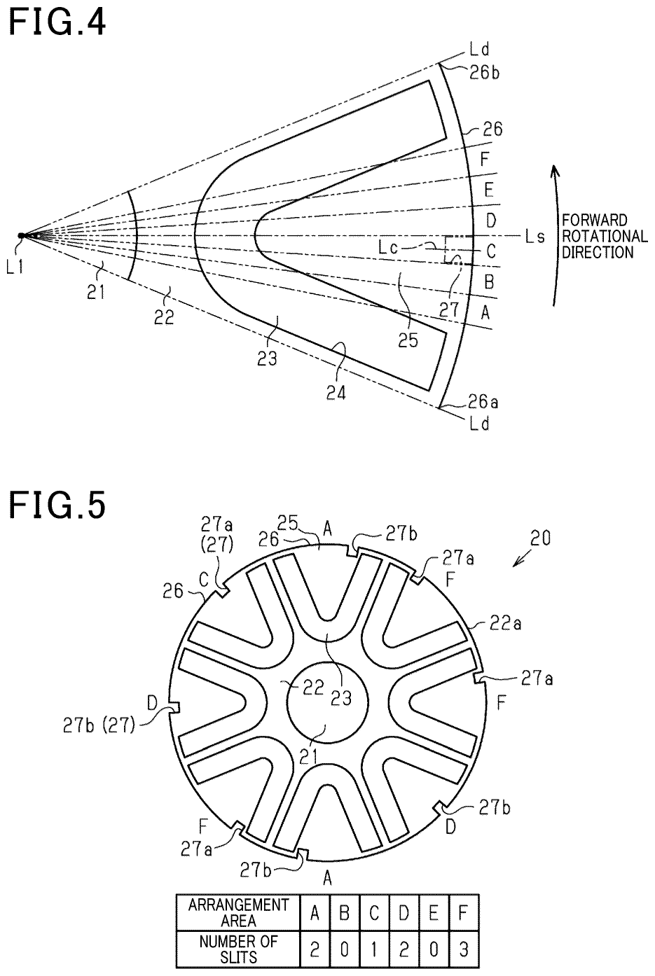

As shown in FIG. 4, in each of the magnetic poles 26, there are set six areas aligned in the circumferential direction. Specifically, each of the magnetic poles 26 is divided into twelve equal areas in the circumferential direction. Counting the twelve areas in the forward rotational direction in order of proximity to the first end 26a, the fourth to ninth areas are respectively defined as a first area A, a second area B, a third area C, a fourth area D, a fifth area E and a sixth area F. The opening angle of each of the areas A to F about the axis L1 is equal to an angle obtained by equally dividing the magnetic-pole opening angle θm by twelve, more particularly equal to 3.75° in the present embodiment. In addition, all of the first area A to the sixth area F are set within the range of the magnetic pole pitch Lp.

In each of the magnetic poles 26, the position of the slit 27 is set so that a circumferential center Lc of the slit 27 is located in one of the areas A to F. In FIG. 4, an example of the slit 27 formed in one of the magnetic poles 26 is illustrated with two-dot chain lines. In this example, the position of the slit 27 is set so that the circumferential center Lc of the slit 27 is located in the area C. In addition, hereinafter, for the sake of convenience of explanation, the fact that the circumferential center Lc of the slit 27 is located in one of the areas A to F will be simply described as “the slit 27 is arranged in the area”, omitting the description of the circumferential center Lc.

FIG. 5 illustrates an example of the arrangement of the slits 27 in the magnetic poles 26. As shown in FIG. 5, the eight slits 27 formed respectively in the eight magnetic poles 26 include at least one first slit 27a and at least one second slit 27b. The first slit 27a is a slit 27 that is arranged in the third area C or a slit 27 that is arranged in the sixth area F. The second slit 27b is arranged in one of the first area A, the second area B, the third area C, the fourth area D, the fifth area E and the sixth area F. It should be noted that in FIG. 5, the reference signs designating the arrangement areas of the slits 27 are shown on the radially outer side of each of the magnetic poles 26.

As shown in FIG. 5, the number of the slits 27 arranged in the first areas A of the magnetic poles 26 is two. The number of the slits 27 arranged in the second areas B of the magnetic poles 26 is zero. The number of the slits 27 arranged in the third areas C of the magnetic poles 26 is one. The number of the slits 27 arranged in the fourth areas D of the magnetic poles 26 is two. The number of the slits 27 arranged in the fifth areas E of the magnetic poles 26 is zero. The number of the slits 27 arranged in the sixth areas F of the magnetic poles 26 is three. Moreover, the slits 27 are sequentially arranged, from the slit 27 of the magnetic pole 26 located uppermost in FIG. 5, in the forward rotational direction (i.e., the counterclockwise direction) respectively in the first area A, the third area C, the fourth area D, the sixth area F, the first area A, the fourth area D, the sixth area F and the sixth area F. It should be noted that the order of the arrangement areas of the slits 27 in the circumferential direction is not limited to the above example, but may be changed as appropriate. Moreover, in the example shown in FIG. 5, of the areas A to F, there exist areas where no slit 27 is arranged. Specifically, in this example, the areas where no slit 27 is arranged are the second area B and the fifth area E.

(Rotational 24th-Order Torque Ripple)

A second slit 27b is arranged at a position where it generates torque ripple whose phase is opposite to that of rotational (3×P)th-order torque ripple generated by a first slit 27a. In the rotor 20 according to the present embodiment, the number P of magnetic poles is eight. Therefore, the second slit 27b is arranged at a position where it generates torque ripple whose phase is opposite to that of rotational 24th-order torque ripple generated by the first slit 27a.

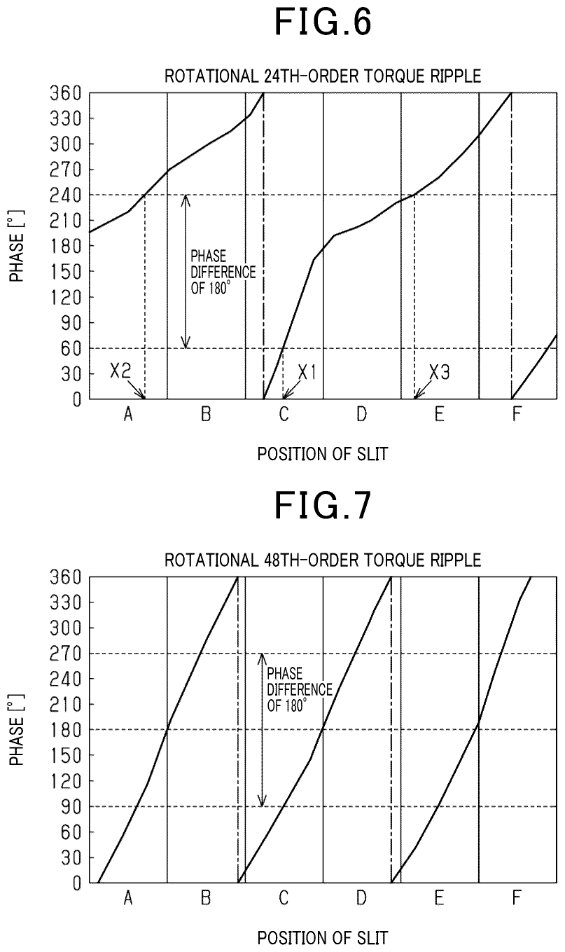

FIG. 6 illustrates the relationship between the position of a slit 27 and the phase of the rotational 24th-order torque ripple generated by the slit 27. As shown in FIG. 6, when the position of the slit 27 is changed from one end to the other end of the first area A, the phase is changed in a range from about 195° to about 270°, i.e., the width of the phase range is about 75°. When the position of the slit 27 is changed from one end to the other end of the second area B, the phase is changed in a range from about 270° to about 330°, i.e., the width of the phase range is about 60°. When the position of the slit 27 is changed from one end to the other end of the third area C, the phase is changed in a range from about 330° to about 180°, i.e., the width of the phase range is about 210°. When the position of the slit 27 is changed from one end to the other end of the fourth area D, the phase is changed in a range from about 180° to about 230°, i.e., the width of the phase range is about 50°. When the position of the slit 27 is changed from one end to the other end of the fifth area E, the phase is changed in a range from about 230° to about 310°, i.e., the width of the phase range is about 80°. When the position of the slit 27 is changed from one end to the other end of the sixth area F, the phase is changed in a range from about 310° to about 75°, i.e., the width of the phase range is about 125°. As described above, of the areas A to F, those areas where the width of the phase range is greater than 90° when the position of the slit 27 is changed are the third area C and the sixth area F.

The second slit 27b is arranged at a position where it generates torque ripple whose phase is opposite to (i.e., different by 180° from) that of the rotational 24th-order torque ripple generated by the first slit 27a. Consequently, the torque ripples of the rotational 24th order generated respectively by the first slit 27a and the second slit 27b interfere with each other and thereby attenuate each other. As a result, it becomes possible to suppress the total rotational 24th-order torque ripple.

For example, assume that the first slit 27a is arranged at a first position X1 in the third area C in one of the magnetic poles 26, as shown in FIG. 6. In this case, the phase of the rotational 24th-order torque ripple generated by the first slit 27a arranged at the first position X1 is 60°. Therefore, the position of the second slit 27b is set to either a second position X2 or a third position X3 at each of which the second slit 27b generates torque ripple whose phase is different by 180° from 60°, i.e., is 240°. The second position X2 is a position in the first area A, whereas the third position X3 is a position in the fifth area E. In this manner, the positions of the first slit 27a and the second slit 27b are set to those positions where the phases of the torque ripples of the rotational 24th order generated respectively by the first slit 27a and the second slit 27b are opposite to each other.

Each of the third area C and the sixth area F has the phase range width greater than or equal to 90°, which is greater than those of the other areas. Therefore, setting at least one of the slits 27 of the magnetic poles 26 to be the first slit 27a arranged in the third area C or the sixth area F, it is possible to improve the degree of freedom in setting the position of the second slit 27b so as to enable the second slit 27b to generate torque ripple in the opposite phase to that generated by the first slit 27a.

(Rotational 48th-Order Torque Ripple)

Moreover, a second slit 27b is arranged at a position where it generates torque ripple whose phase is opposite to that of rotational (6×P)th-order torque ripple generated by a first slit 27a. In the rotor 20 according to the present embodiment, the number P of magnetic poles is eight. Therefore, the second slit 27b is arranged at a position where it generates torque ripple whose phase is opposite to that of rotational 48th-order torque ripple generated by the first slit 27a. Consequently, the torque ripples of the rotational 48th order generated respectively by the first slit 27a and the second slit 27b interfere with each other and thereby attenuate each other. As a result, it becomes possible to suppress the total rotational 48th-order torque ripple.

FIG. 7 illustrates the relationship between the position of a slit 27 and the phase of the rotational 48th-order torque ripple generated by the slit 27. As shown in FIG. 7, in each of the first area A, the third area C and the fifth area E, when the position of the slit 27 is changed from one end to the other end of the area, the phase is changed in a range from about 0° to about 180°, i.e., the width of the phase range is about 180°. On the other hand, in each of the second area B, the fourth area D and the sixth area F, when the position of the slit 27 is changed from one end to the other end of the area, the phase is changed in a range from about 180° to about 360°, i.e., the width of the phase range is also about 180°.

Therefore, a second slit 27b, which generates rotational 48th-order torque ripple in the opposite phase to that generated by a first slit 27a arranged in the third area C, is arranged in one of the second area B, the fourth area D and the sixth area F. Otherwise, a second slit 27b, which generates rotational 48th-order torque ripple in the opposite phase to that generated by a first slit 27a arranged in the sixth area F, is arranged in one of the first area A, the third area C and the fifth area E.

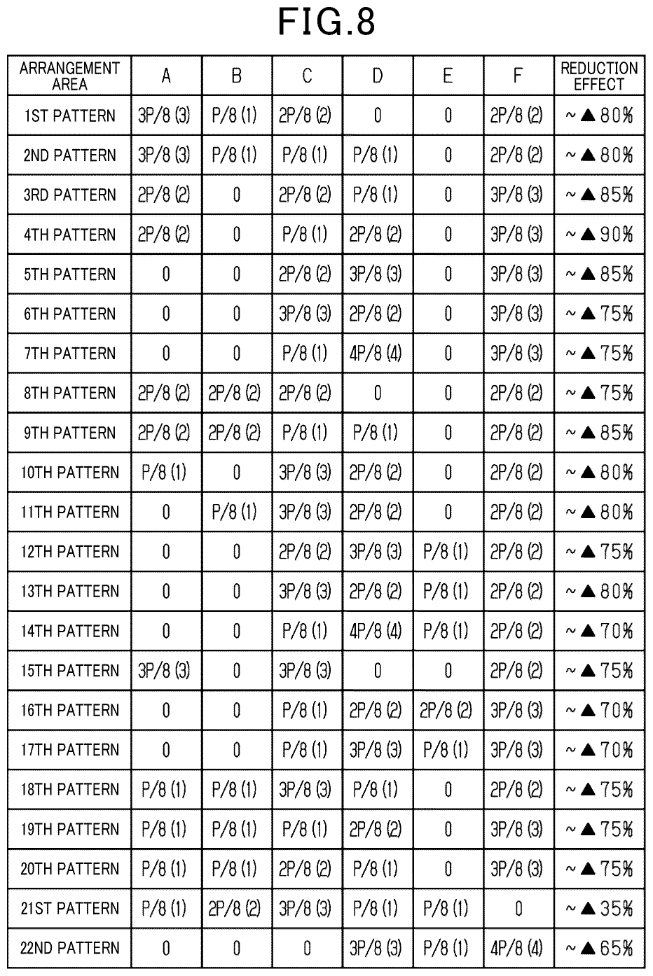

FIG. 8 is a table showing 22 patterns of arranging the slits 27 in the magnetic poles 26; the 22 patterns are significantly effective in reducing torque ripple. In the table, there are shown the numbers of the slits 27 arranged in the first area A to the sixth area F in each of the 22 patterns. It should be noted that in the table, P is the number of magnetic poles of the rotor 20. It also should be noted that in the table, the numbers in parentheses represent the numbers of the slits 27 when the number P of magnetic poles of the rotor 20 is eight.

The reduction effect of each pattern in the table is represented by the ratio of the amount of reduction of torque ripple achievable with the pattern to torque ripple of a rotor having a comparative configuration. The comparative configuration is a configuration in which the slits 27 are omitted from the rotor 20 according to the present embodiment. That is, in the rotor having the comparative configuration, the outer circumferential surface 22a of the rotor core 22 has a circular shape without irregularities when viewed in the axial direction.

The arrangement pattern of the slits 27 in the rotor 20 shown in FIG. 5 is the fourth pattern of the 22 patterns shown in FIG. 8. With the fourth pattern, torque ripple is reduced by 90% compared to the comparative configuration. In addition, among the 22 patterns, the fourth pattern has the highest effect in reducing torque ripple.

As shown in FIG. 8, with each of the third, fifth and ninth patterns of the 22 patterns, torque ripple is reduced by 85% compared to the comparative configuration. With each of the first, second, tenth, eleventh and thirteenth patterns of the 22 patterns, torque ripple is reduced by 80% compared to the comparative configuration. With each of the sixth, seventh, eighth, twelfth, fifteenth, eighteenth, nineteenth and twentieth patterns of the 22 patterns, torque ripple is reduced by 75% compared to the comparative configuration. With each of the fourteenth, sixteenth and seventeenth patterns of the 22 patterns, torque ripple is reduced by 70% compared to the comparative configuration. With the twenty-second pattern of the 22 patterns, torque ripple is reduced by 65% compared to the comparative configuration. With the twenty-first pattern of the 22 patterns, torque ripple is reduced by 35% compared to the comparative configuration.

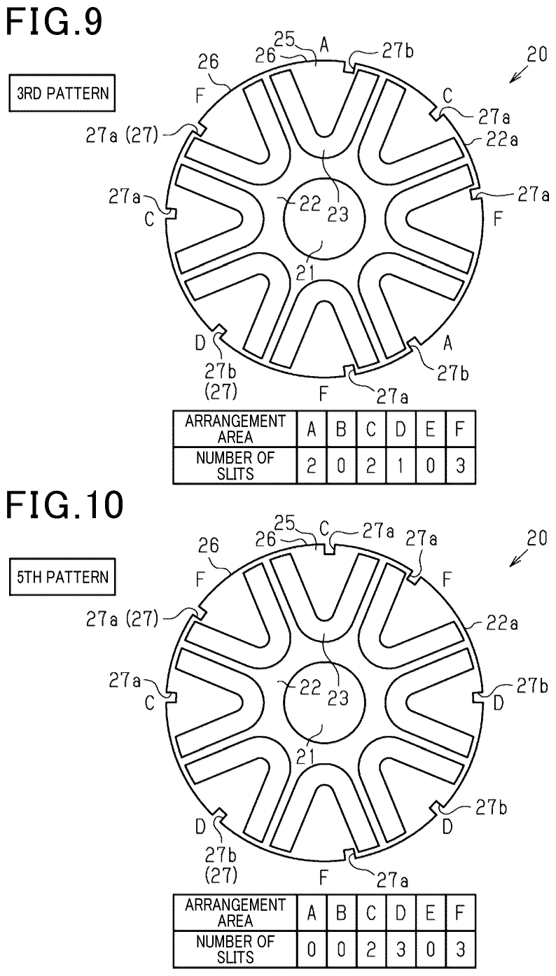

FIG. 9 shows a rotor 20 in which the slits 27 are arranged in the third pattern. Specifically, when the number P of magnetic poles of the rotor 20 is eight, in the third pattern, the number of the slits 27 arranged in the first areas A of the magnetic poles 26 is two. Moreover, the number of the slits 27 arranged in the second areas B of the magnetic poles 26 is zero. The number of the slits 27 arranged in the third areas C of the magnetic poles 26 is two. The number of the slits 27 arranged in the fourth areas D of the magnetic poles 26 is one. The number of the slits 27 arranged in the fifth areas E of the magnetic poles 26 is zero. The number of the slits 27 arranged in the sixth areas F of the magnetic poles 26 is three. Moreover, the slits 27 are sequentially arranged, from the slit 27 of the magnetic pole 26 located uppermost in FIG. 9, in the forward rotational direction (i.e., the counterclockwise direction) respectively in the first area A, the sixth area F, the third area C, the fourth area D, the sixth area F, the first area A, the sixth area F and the third area C. It should be noted that the order of the arrangement areas of the slits 27 in the circumferential direction is not limited to the example shown in FIG. 9, but may be changed as appropriate.

FIG. 10 shows a rotor 20 in which the slits 27 are arranged in the fifth pattern. Specifically, when the number P of magnetic poles of the rotor 20 is eight, in the fifth pattern, the number of the slits 27 arranged in the first areas A of the magnetic poles 26 is zero. Moreover, the number of the slits 27 arranged in the second areas B of the magnetic poles 26 is also zero. The number of the slits 27 arranged in the third areas C of the magnetic poles 26 is two. The number of the slits 27 arranged in the fourth areas D of the magnetic poles 26 is three. The number of the slits 27 arranged in the fifth areas E of the magnetic poles 26 is zero. The number of the slits 27 arranged in the sixth areas F of the magnetic poles 26 is three. Moreover, the slits 27 are sequentially arranged, from the slit 27 of the magnetic pole 26 located uppermost in FIG. 10, in the forward rotational direction (i.e., the counterclockwise direction) respectively in the third area C, the sixth area F, the third area C, the fourth area D, the sixth area F, the fourth area D, the fourth area D and the sixth area F. It should be noted that the order of the arrangement areas of the slits 27 in the circumferential direction is not limited to the example shown in FIG. 10, but may be changed as appropriate.

FIG. 11 shows a rotor 20 in which the slits 27 are arranged in the eighth pattern. Specifically, when the number P of magnetic poles of the rotor 20 is eight, in the eighth pattern, the number of the slits 27 arranged in the first areas A of the magnetic poles 26 is two. Moreover, the number of the slits 27 arranged in the second areas B of the magnetic poles 26 is also two. The number of the slits 27 arranged in the third areas C of the magnetic poles 26 is also two. The number of the slits 27 arranged in the fourth areas D of the magnetic poles 26 is zero. The number of the slits 27 arranged in the fifth areas E of the magnetic poles 26 is also zero. The number of the slits 27 arranged in the sixth areas F of the magnetic poles 26 is two. Moreover, the slits 27 are sequentially arranged, from the slit 27 of the magnetic pole 26 located uppermost in FIG. 11, in the forward rotational direction (i.e., the counterclockwise direction) respectively in the first area A, the third area C, the sixth area F, the second area B, the first area A, the third area C, the sixth area F and the second area B.

In the rotor 20 shown in FIG. 11, the arrangement areas of the slits 27 are identical for each pair of the magnetic poles 26 located 180° opposite to each other. Specifically, the pair of the magnetic poles 26 having the respective slits 27 arranged in the first areas A thereof are located 180° opposite to each other. Similarly, the pair of the magnetic poles 26 having the respective slits 27 arranged in the second areas B thereof are located 180° opposite to each other. The pair of the magnetic poles 26 having the respective slits 27 arranged in the third areas C thereof are located 180° opposite to each other. The pair of the magnetic poles 26 having the respective slits 27 arranged in the sixth areas F thereof are located 180° opposite to each other. Consequently, it becomes possible to reduce both magnetic imbalance and mass imbalance in the radial direction of the rotor 20.

Next, advantageous effects achievable according to the present embodiment will be described.

(1) In the present embodiment, each of the magnetic poles 26 of the rotor 20 has one slit 27 formed in the corresponding outer core portion 25 of the rotor core 22. The slits 27 of the magnetic poles 26 include at least one first slit 27a and at least one second slit 27b. The first slit 27a is arranged in the third area C or the sixth area F. The second slit 27b is arranged in one of the first area A, the second area B, the third area C, the fourth area D, the fifth area E and the sixth area F.

With the above configuration, the width of the phase range of the torque ripple when the position of a slit 27 is changed in the circumferential direction is greater in the third area C and the sixth area F than in the other areas (see FIG. 6). Therefore, with the first slit 27a arranged in the third area C or the sixth area F, it is possible to improve the degree of freedom in setting the position of the second slit 27b so as to enable the second slit 27b to generate torque ripple in the opposite phase to that generated by the first slit 27a. Moreover, according to the present embodiment, the number of the slits 27 provided in each of the magnetic poles 26 is one; consequently, it becomes possible to minimize the decrease in the rotational torque which is caused by the provision of the slits 27.

(2) The second slit 27b is arranged, in one of the first area A, the second area B, the third area C, the fourth area D, the fifth area E and the sixth area F, at a position where it generates torque ripple whose phase is opposite to that of rotational (3×P)th-order torque ripple generated by the first slit 27a.

With the above configuration, the torque ripples of the rotational (3×P)th order generated respectively by the first slit 27a and the second slit 27b attenuate each other. Consequently, it becomes possible to suppress increase in the total rotational (3×P)th-order torque ripple.

(3) Each of the permanent magnets 23 is configured to have, when viewed in the axial direction, the folded shape that is convex inward in the radial direction of the rotor 20. With this configuration, it becomes possible to secure a large surface area of each of the permanent magnets 23 facing the corresponding outer core portions 25. Consequently, it becomes possible to improve the magnet torque. Moreover, with this configuration, it also becomes possible to secure a large volume of each of the outer core portions 25. Consequently, it becomes possible to improve the reluctance torque as well. As a result, it becomes possible to increase the total torque of the rotating electric machine M.

(4) The distance between the intersection points between the extension lines of the inside surface of each of the permanent magnets 23 having the folded shape and the outer circumferential surface 22a of the rotor core 22 is defined as the magnetic pole pitch Lp. Moreover, in each of the magnetic poles 26, all of the first area A, the second area B, the third area C, the fourth area D, the fifth area E and the sixth area F are set within the range of the magnetic pole pitch Lp. Consequently, it becomes possible to provide each of the slits 27 within the range of the magnetic pole pitch Lp.

(5) The slits 27 of the magnetic poles 26 include a first slit 27a arranged in the third area C. Moreover, a second slit 27b is arranged, in one of the second area B, the fourth area D and the sixth area F, at a position where it generates torque ripple whose phase is opposite to that of rotational (6×P)th-order torque ripple generated by the first slit 27a. With this configuration, the torque ripples of the rotational (6×P)th order generated respectively by the first slit 27a and the second slit 27b attenuate each other. Consequently, it becomes possible to suppress increase in the total rotational (6×P)th-order torque ripple.

(6) The slits 27 of the magnetic poles 26 also include a first slit 27a arranged in the sixth area F. Moreover, a second slit 27b is arranged, in one of the first area A, the third area C and the fifth area E, at a position where it generates torque ripple whose phase is opposite to that of rotational (6×P)th-order torque ripple generated by the first slit 27a. With this configuration, the torque ripples of the rotational (6×P)th order generated respectively by the first slit 27a and the second slit 27b attenuate each other. Consequently, it becomes possible to suppress increase in the total rotational (6×P)th-order torque ripple.

(7) At least one of the first area A, the second area B, the third area C, the fourth area D, the fifth area E and the sixth area F is set, in all of the magnetic poles 26, as an area where no slit 27 is arranged. Consequently, it becomes possible to cause the torque ripples of the rotational (3×P)th order generated by the slits 27 to suitably interfere with each other, thereby effectively reducing the total torque ripple the rotational (3×P)th order.

For example, in the above-described embodiment, assume that: a slit 27 is arranged in the first area A in one of the magnetic poles 26; and another slit 27 is arranged in the second area B in another of the magnetic poles 26. In this case, the phase range of the rotational 24th-order torque ripple generated by the slit 27 arranged in the first area A is from about 195° to about 270°; and the phase range of the rotational 24th-order torque ripple generated by the slit 27 arranged in the second area B is from about 270° to about 330° (see FIG. 6). Therefore, it is impossible to realize a phase difference of 180° between the rotational 24th-order torque ripple generated by the slit 27 arranged in the first area A and the rotational 24th-order torque ripple generated by the slit 27 arranged in the second area B. Accordingly, by setting, in all of the magnetic poles 26, one of the first area A and the second area B as an area where no slit 27 is arranged, it is possible to suitability reduce the total rotational 24th-order torque ripple. The same applies to the fourth area D and the fifth area E. That is, by setting, in all of the magnetic poles 26, one of the fourth area D and the fifth area E as an area where no slit 27 is arranged, it is possible to suitability reduce the total rotational 24th-order torque ripple.

(8) The arrangement areas of the slits 27 are identical for each pair of the magnetic poles 26 located 180° opposite to each other. With this configuration, it becomes possible to reduce both magnetic imbalance and mass imbalance in the radial direction of the rotor 20.

### Modifications

The present embodiment can be modified and implemented as follows. Moreover, the present embodiment and the following modifications can also be implemented in combination with each other to the extent that there is no technical contradiction between them.

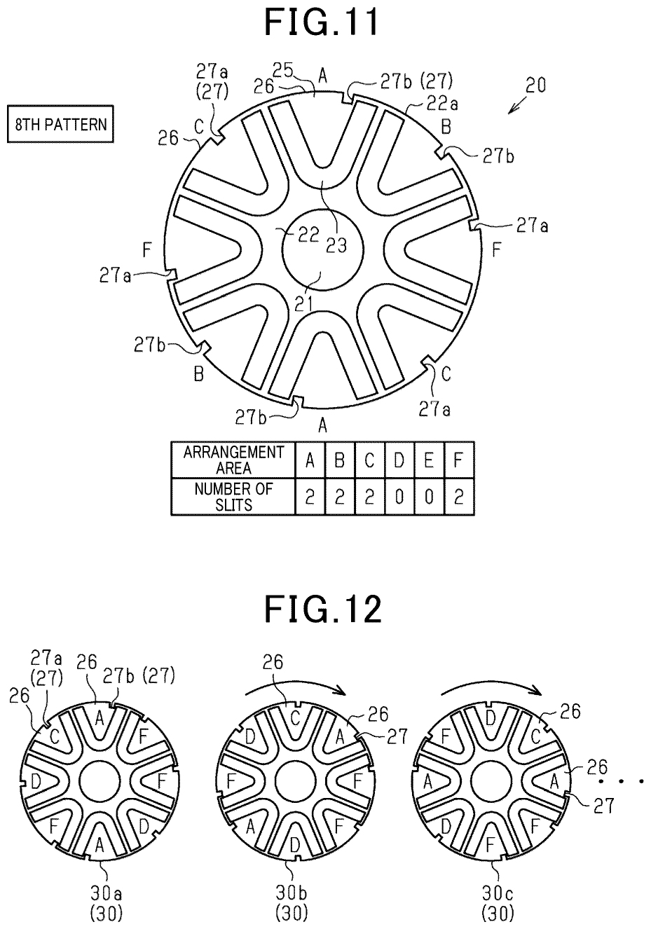

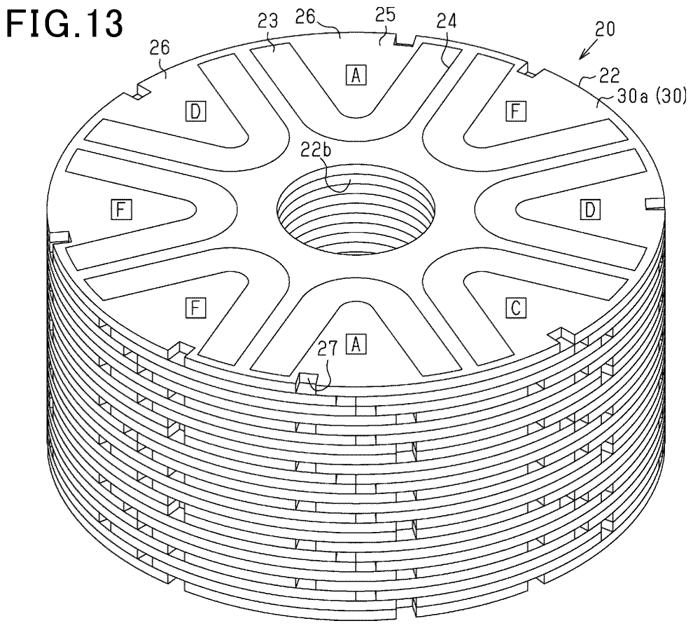

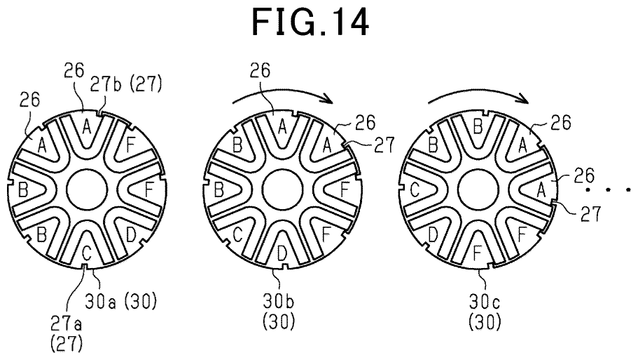

In the rotor 20 according to the above-described embodiment, the rotor core 22 may be formed by laminating core sheets while rotating them. For example, as shown in FIGS. 12 and 13, the rotor core 22 may be formed of a plurality of core sheets 30 laminated in the axial direction. Moreover, each of the core sheets 30 may be constituted of, for example, a magnetic steel sheet.

In each of the core sheets 30, there are formed a plurality of slits 27 which include at least one first slit 27a and at least one second slit 27b. All the core sheets 30 have the same configuration. That is, all the core sheets 30 are configured to have the same arrangement of the slits 27. In the example shown in FIGS. 12 and 13, each of the core sheets 30 has the slits 27 arranged in the fourth pattern shown in FIG. 5.

The rotor core 22 may be formed by laminating the core sheets 30 in a state of having been rotated by 360°/P in units of one core sheet 30. Specifically, in the example shown in FIGS. 12 and 13, assume that: a first core sheet 30a is located uppermost in the rotor core 22; a second core sheet 30b located immediately below the first core sheet 30a; and a third core sheet 30c located immediately below the second core sheet 30b.

In this example, the second core sheet 30b is in a state of having been rotated clockwise by 45° with respect to the first core sheet 30a. Further, the third core sheet 30c is in a state of having been rotated clockwise by 45° with respect to the second core sheet 30b. Similarly, each of the fourth and subsequent core sheets 30 is in a state of having been rotated clockwise by 45° with respect to the core sheet 30 located immediately above it.

In each of the magnetic poles 26 of the rotor 20 that is formed of the core sheets 30 laminated in the above manner, the positions of the slits 27 are not aligned in a straight line along the axial direction. For example, in the magnetic pole 26 located uppermost in FIG. 12, the arrangement areas of the slits 27 in the core sheets 30 are sequentially changed, from the first core sheet 30a, in units of one core sheet 30 as follows: the first area A, the third area C, the fourth area D, the sixth area F, the first area A, the fourth area D, the sixth area F, the sixth area F, . . . .

As described above, the rotor core 22 may be formed, by laminating the core sheets 30 while rotating them by 360°/P, so that the positions of the slits 27 are not constant in each of the magnetic poles 26. In this case, it is possible to reduce both magnetic imbalance and mass imbalance in the radial direction of the rotor 20. Moreover, it is also possible to reduce magnetic imbalance in the axial direction of the rotor 20. Furthermore, by laminating the core sheets 30 while rotating them by 360°/P, it is also possible to reduce rotational Sth-order torque ripple in the rotating electric machine M where the number of slots is S. For example, when the number S of slots is twelve, it is possible to reduce rotational 12th-order torque ripple.

In the example shown in FIGS. 12 and 13, each of the core sheets 30 has the slits 27 arranged in the fourth pattern shown in FIG. 5. Alternatively, each of the core sheets 30 may have the slits 27 arranged in other patterns, for example in the pattern shown in FIG. 14. In the example shown in FIG. 14, each of the core sheets 30 has the slits 27 arranged in the ninth pattern of the 22 patterns shown in FIG. 8. Specifically, when the number P of magnetic poles of the rotor 20 is eight, in the ninth pattern, the number of the slits 27 arranged in the first areas A of the magnetic poles 26 is two. Moreover, the number of the slits 27 arranged in the second areas B of the magnetic poles 26 is also two. The number of the slits 27 arranged in the third areas C of the magnetic poles 26 is one. The number of the slits 27 arranged in the fourth areas D of the magnetic poles 26 is also one. The number of the slits 27 arranged in the fifth areas E of the magnetic poles 26 is zero. The number of the slits 27 arranged in the sixth areas F of the magnetic poles 26 is two. Moreover, the slits 27 are sequentially arranged, from the slit 27 of the magnetic pole 26 located uppermost in FIG. 14, in the forward rotational direction (i.e., the counterclockwise direction) respectively in the first area A, the first area A, the second area B, the second area B, the third area C, the fourth area D, the sixth area F and the sixth area F.

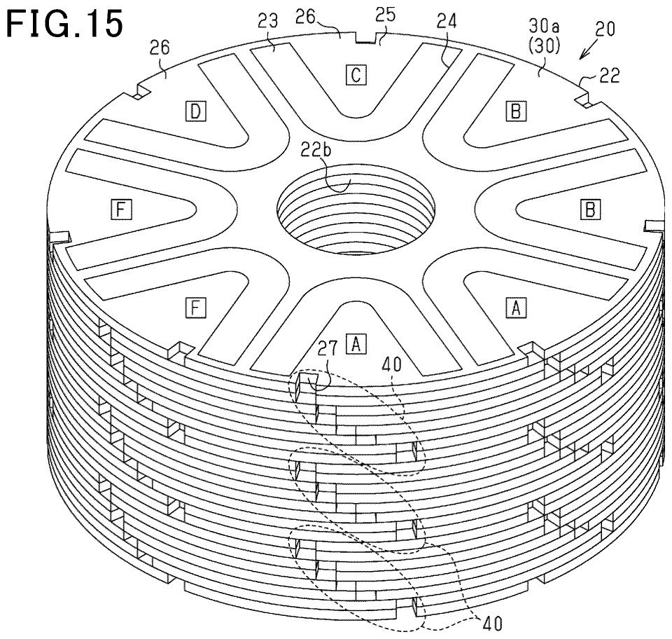

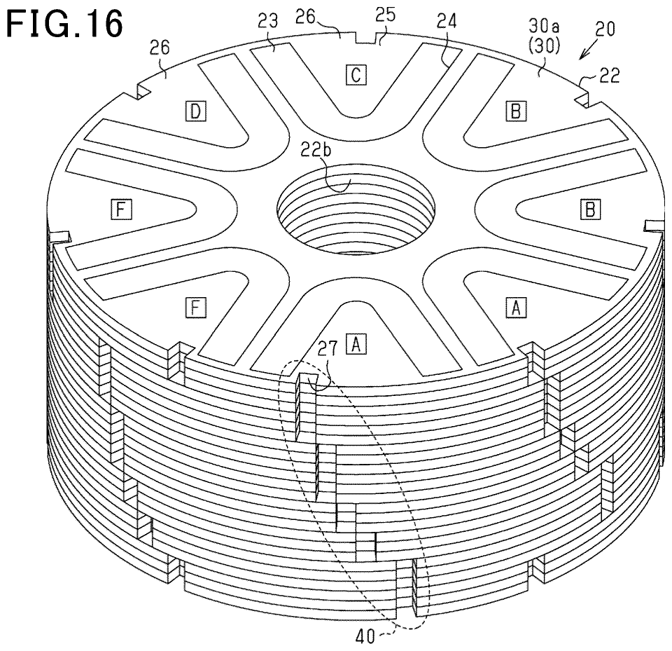

FIG. 15 shows a rotor 20 that is formed by laminating the core sheets 30 shown in FIG. 14 while rotating them clockwise by 360°/P in units of one core sheet 30. Specifically, in the rotor 20 shown in FIG. 15, there are formed skew portions 40 in which the slits 27 of the core sheets 30 are offset in the circumferential direction with change in the positions of the slits 27 in the axial direction. In the example shown in FIGS. 14 and 15, the skew portions 40 are formed by setting the arrangement areas of the slits 27 of the magnetic poles 26 in ascending or descending order in the forward rotational direction. More specifically, in this example, the slit 27 of the magnetic pole 26, which is adjacent in the forward rotational direction to a magnetic pole 26 having its slit 27 arranged in the first area A, is arranged in one of the first area A to the sixth area F. Moreover, the slit 27 of the magnetic pole 26, which is adjacent in the forward rotational direction to a magnetic pole 26 having its slit 27 arranged in the second area B, is arranged in one of the second area B to the sixth area F. Furthermore, the slit 27 of the magnetic pole 26, which is adjacent in the forward rotational direction to a magnetic pole 26 having its slit 27 arranged in the third area C, is arranged in one of the third area C to the sixth area F. Furthermore, the slit 27 of the magnetic pole 26, which is adjacent in the forward rotational direction to a magnetic pole 26 having its slit 27 arranged in the fourth area D, is arranged in one of the fourth area D to the sixth area F. With this configuration, torque ripple can be more effectively reduced by the skew portions 40 that are formed by the slits 27 of the core sheets 30. In addition, both magnetic imbalance and mass imbalance in the radial and axial directions of the rotor 20 can also be reduced by the skew portions 40.

The arrangement of the slits 27 that form the skew portions 40 in the laminated state of the core sheets 30 is not limited to that shown in FIG. 14. For example, the slits 27 of the magnetic poles 26 may alternatively be arranged in the forward rotational direction in the order of the first area A, the second area B, the third area C, the sixth area F, the first area A, the second area B, the fourth area D and the sixth area F. With this alternative arrangement, it is also possible to form skew portions by the slits 27 of the core sheets 30. Moreover, in the case of setting the numbers of the slits 27 in the areas A to F to be different from those shown in FIG. 14, it is still possible to form skew portions by the slits 27 of the core sheets 30.

In the examples shown in FIGS. 12 to 15, the core sheets 30 are laminated in a state of having been rotated by 360°/P in units of one core sheet 30. However, the present disclosure is not limited to these examples. Alternatively, as shown in FIG. 16, the core sheets 30 may be laminated in a state of having been rotated by 360°/P in units of two or more core sheets 30. FIG. 16 shows, as an example, a rotor 20 in which the core sheets 30 shown in FIG. 14 are laminated in a state of having been rotated by 360°/P in units of three core sheets 30. In the example shown in FIG. 16, skew portions 40 are formed by the slits 27 of the core sheets 30. With this configuration as well, both magnetic imbalance and mass imbalance in the radial and axial directions of the rotor 20 can be reduced by the skew portions 40. In addition, it is also possible to reduce rotational Sth-order torque ripple in the rotating electric machine M where the number of slots is S. For example, when the number S of slots is twelve, it is possible to reduce rotational 12th-order torque ripple.

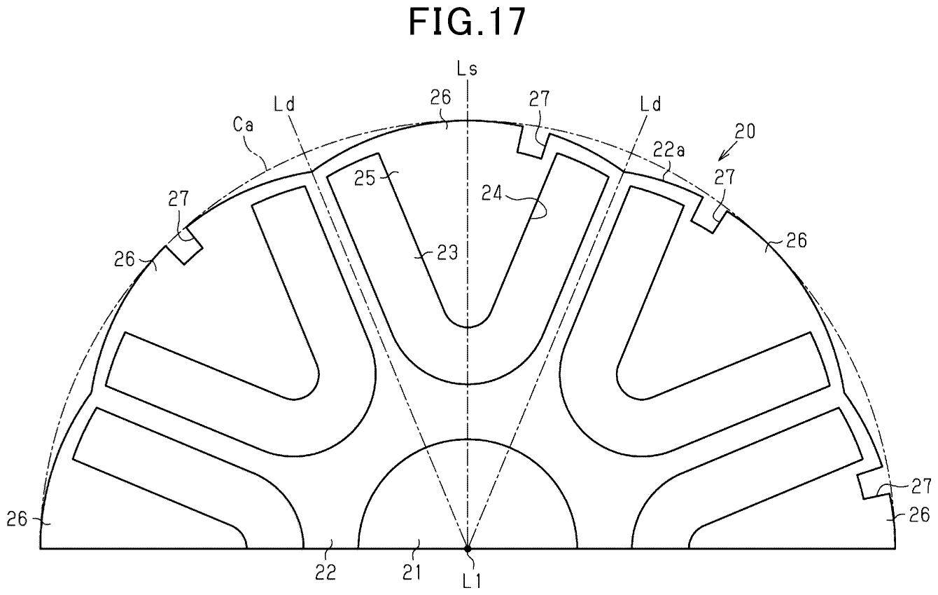

In the above-described embodiment, the shape of the outer circumferential surface 22a of the rotor core 22 in axial view may be changed, for example, as shown in FIG. 17. In the example shown in FIG. 17, the outer circumferential surface 22a of the rotor core 22 has, when viewed in the axial direction, a shape such that it is offset radially inward from the circumferential centerline Ls of each of the magnetic poles 26 to the magnetic-pole boundary lines Ld on both sides of the circumferential centerline Ls. That is, the outer diameter of the rotor core 22, namely the distance from the axis L1 to the outer circumferential surface 22a of the rotor core 22, is not uniform in the circumferential direction. Specifically, the outer diameter of the rotor core 22 is maximum at the circumferential centerline Ls of each of the magnetic poles 26, and is minimum at each of the magnetic-pole boundary lines Ld. In FIG. 17, there is also shown a reference circle Ca whose diameter is equal to the maximum outer diameter of the rotor core 22. In addition, when viewed in the axial direction, the radially outer surface of each of the magnetic poles 26 has the shape of an arc whose diameter is smaller than the diameter of the reference circle Ca.

With the configuration of the rotor core 22 shown in FIG. 17, switching of the magnetic poles 26 becomes smooth since the radially outer surface of each of the magnetic poles 26 has a shape such that it is offset radially inward from the circumferential centerline Ls thereof to the magnetic-pole boundary lines Ld on both sides of the circumferential centerline Ls. Consequently, torque ripple can be further suppressed.

In the above-described embodiment, each of the slits 27 has the shape of a groove having an open radially-outer end. Alternatively, each of the slits 27 may have other shapes, for example a shape having a closed radially-outer end.

The arrangement of the slits 27 in the magnetic poles 26 is not limited to the 22 patterns shown in FIG. 8. Alternatively, the slits 27 may be arranged in other patterns such that the slits 27 include a first slit 27a arranged in the third area C or the sixth area F and a second slit 27b that is arranged, in one of the first area A to the sixth area F, at a position where it generates torque ripple whose phase is opposite to that of rotational (3×P)th-order torque ripple generated by the first slit 27a.

The setting of the first area A to the sixth area F is not limited to that in the above-described embodiment. For example, each of the magnetic poles 26 may be divided into twelve equal areas in the circumferential direction; and counting the twelve areas in the reverse rotational direction in order of proximity to the second end 26b, the fourth to ninth areas may be respectively defined as a first area A, a second area B, a third area C, a fourth area D, a fifth area E and a sixth area F.

The number P of magnetic poles of the rotor 20 is not limited to eight as in the above-described embodiment, but may alternatively be set to seven or less, or nine or more.

The shape of the permanent magnets 23 is not limited to the substantially V-shape, but may alternatively be other folded shapes that are convex radially inward, such as a substantially U-shape. Further, the shape of the permanent magnets 23 may alternatively be non-folded shapes, such as a substantially I-shape.

In the above-described embodiment, the permanent magnets 23 are manufactured by injection-molding the magnet material into the magnet-receiving holes 24 of the rotor core 22. Alternatively, the permanent magnets 23 may be manufactured in advance and inserted into and fixed in the magnet-receiving holes 24 of the rotor core 22.

In addition to the above-described modifications, the configuration of the rotor 20 and the configuration of the rotating electric machine M may be further modified as appropriate.

While the present disclosure has been described pursuant to the embodiments, it should be appreciated that the present disclosure is not limited to the embodiments and the structures. Instead, the present disclosure encompasses various modifications and changes within equivalent ranges. In addition, various combinations and modes are also included in the category and the scope of technical idea of the present disclosure.

### (Notes)

The features of a rotating electric machine according to the present disclosure are summarized as follows.

[1] A rotating electric machine (M) comprising:
a rotor (20) including a rotor core (22) and a plurality of permanent magnets (23) embedded in the rotor core; and
a stator (10) configured to apply a rotating magnetic field to the rotor,
wherein
the rotor has a plurality of magnetic poles (26) formed at equal angular intervals in a circumferential direction,
each of the magnetic poles includes a corresponding one of the permanent magnets and a corresponding portion (25) of the rotor core,
each of the magnetic poles has one slit (27) formed in the corresponding portion of the rotor core,
in each of the magnetic poles, an angle from a first circumferential end (26a) to a second circumferential end (26b) of the magnetic pole is 360°/P, where P is the number of the magnetic poles,
each of the magnetic poles is divided into twelve equal areas between the first and second circumferential ends thereof,
counting the twelve areas in order of proximity to the first circumferential end, the fourth to ninth areas are respectively defined as a first area (A), a second area (B), a third area (C), a fourth area (D), a fifth area (E) and a sixth area (F),
the slits of the magnetic poles include a first slit (27a) and a second slit (27b),
the first slit is arranged in the third area or the sixth area, and
the second slit is arranged in one of the first area, the second area, the third area, the fourth area, the fifth area and the sixth area.

[2] The rotating electric machine according to the above note [1], wherein the second slit is arranged, in one of the first area, the second area, the third area, the fourth area, the fifth area and the sixth area, at a position where it generates torque ripple whose phase is opposite to that of rotational (3×P)th-order torque ripple generated by the first slit.

[3] The rotating electric machine according to the above note [1] or note [2], wherein each of the permanent magnets has a folded shape that is convex inward in a radial direction of the rotor.

[4] The rotating electric machine according to the above note [3], wherein: a distance between intersection points between extension lines of an inside surface of each of the permanent magnets having the folded shape and an outer circumferential surface (22a) of the rotor core is defined as a magnetic pole pitch (Lp); and in each of the magnetic poles, all of the first area, the second area, the third area, the fourth area, the fifth area and the sixth area are set within a range of the magnetic pole pitch.

[5] The rotating electric machine according to any one of the above notes [1] to [4], wherein: the first slit is arranged in the third area; and the second slit is arranged, in one of the second area, the fourth area and the sixth area, at a position where it generates torque ripple whose phase is opposite to that of rotational (6×P)th-order torque ripple generated by the first slit.

[6] The rotating electric machine according to any one of the above notes [1] to [4], wherein: the first slit is arranged in the sixth area; and the second slit is arranged, in one of the first area, the third area and the fifth area, at a position where it generates torque ripple whose phase is opposite to that of rotational (6×P)th-order torque ripple generated by the first slit.

[7] The rotating electric machine according to any one of the above notes [1] to [6], wherein at least one of the first area, the second area, the third area, the fourth area, the fifth area and the sixth area is set, in all of the magnetic poles, as an area where no slit is arranged.

[8] The rotating electric machine according to any one of the above notes [1] to [7], wherein the arrangement areas of the slits are identical for each pair of the magnetic poles located 180° opposite to each other.

[9] The rotating electric machine according to any one of the above notes [1] to [8], wherein: the rotor core is formed of a plurality of core sheets (30) laminated in an axial direction; the core sheets are identical in configuration to each other; in each of the core sheets, there are formed the slits including the first slit and the second slit; and the rotor core is formed by laminating the core sheets in a state of having been rotated by 360°/P in units of a predetermined number of the core sheets.

[10] The rotating electric machine according to the above note [9], wherein the rotor core is formed by laminating the core sheets in a state of having been rotated by 360°/P in units of one core sheet.

[11] The rotating electric machine according to the above note [9] or note [10], wherein the slits of the core sheets are arranged to form, in a laminated state of the core sheets, skew portions (40) in which the slits of the core sheets are offset in the circumferential direction with change in positions of the slits in the axial direction.

What is claimed is:

1. A rotating electric machine comprising:
a rotor including a rotor core and a plurality of permanent magnets embedded in the rotor core; and
a stator configured to apply a rotating magnetic field to the rotor,
wherein
the rotor has a plurality of magnetic poles formed at equal angular intervals in a circumferential direction,
each of the magnetic poles includes a corresponding one of the permanent magnets and a corresponding portion of the rotor core,
each of the magnetic poles has one slit formed in the corresponding portion of the rotor core,
in each of the magnetic poles, an angle from a first circumferential end to a second circumferential end of the magnetic pole is 360°/P, where P is the number of the magnetic poles,
each of the magnetic poles is divided into twelve equal areas between the first and second circumferential ends thereof,
counting the twelve areas in order of proximity to the first circumferential end, the fourth to ninth areas are respectively defined as a first area, a second area, a third area, a fourth area, a fifth area and a sixth area,
the slits of the magnetic poles include a first slit and a second slit,
the first slit is arranged in the third area or the sixth area, and
the second slit is arranged in one of the first area, the second area, the third area, the fourth area, the fifth area and the sixth area.

2. The rotating electric machine as set forth in claim 1, wherein
the second slit is arranged, in one of the first area, the second area, the third area, the fourth area, the fifth area and the sixth area, at a position where it generates torque ripple whose phase is opposite to that of rotational (3×P)th-order torque ripple generated by the first slit.

3. The rotating electric machine as set forth in claim 1, wherein
each of the permanent magnets has a folded shape that is convex inward in a radial direction of the rotor.

4. The rotating electric machine as set forth in claim 3, wherein
a distance between intersection points between extension lines of an inside surface of each of the permanent magnets having the folded shape and an outer circumferential surface of the rotor core is defined as a magnetic pole pitch, and
in each of the magnetic poles, all of the first area, the second area, the third area, the fourth area, the fifth area and the sixth area are set within a range of the magnetic pole pitch.

5. The rotating electric machine as set forth in claim 1, wherein
the first slit is arranged in the third area, and
the second slit is arranged, in one of the second area, the fourth area and the sixth area, at a position where it generates torque ripple whose phase is opposite to that of rotational (6×P)th-order torque ripple generated by the first slit.

6. The rotating electric machine as set forth in claim 1, wherein
the first slit is arranged in the sixth area, and
the second slit is arranged, in one of the first area, the third area and the fifth area, at a position where it generates torque ripple whose phase is opposite to that of rotational (6×P)th-order torque ripple generated by the first slit.

7. The rotating electric machine as set forth in claim 1, wherein
at least one of the first area, the second area, the third area, the fourth area, the fifth area and the sixth area is set, in all of the magnetic poles, as an area where no slit is arranged.

8. The rotating electric machine as set forth in claim 1, wherein
the arrangement areas of the slits are identical for each pair of the magnetic poles located 180° opposite to each other.

9. The rotating electric machine as set forth in claim 1, wherein
the rotor core is formed of a plurality of core sheets laminated in an axial direction,
the core sheets are identical in configuration to each other,
in each of the core sheets, there are formed the slits including the first slit and the second slit, and
the rotor core is formed by laminating the core sheets in a state of having been rotated by 360°/P in units of a predetermined number of the core sheets.

10. The rotating electric machine as set forth in claim 9, wherein
the rotor core is formed by laminating the core sheets in a state of having been rotated by 360°/P in units of one core sheet.

11. The rotating electric machine as set forth in claim 9, wherein
the slits of the core sheets are arranged to form, in a laminated state of the core sheets, skew portions in which the slits of the core sheets are offset in the circumferential direction with change in positions of the slits in the axial direction.
